(19) United States
(12) Patent Application Publication
(10) Pub. No.: US 2025/0239177 A1
(43) Pub. Date: Jul. 24, 2025

(54) METHODS AND SYSTEMS FOR SURGICAL TRAINING

(71) Applicant: Virginia Commonwealth University, Richmond, VA (US)

(72) Inventors: Lauren Siff, Richmond, VA (US); Milos Manic, Henrico, VA (US); Lewis Franklin Bost, Richmond, VA (US); Vasileios Tsouvalas, Mount Sinai, NY (US)

(21) Appl. No.: 18/853,112

(22) PCT Filed: May 4, 2023
(86) PCT No.: PCT/US23/66595

§ 371 Date: Sep. 30, 2024

(51) Int. Cl. G09B 23/28; G09B 23/30

(52) U.S. Cl. CPC G09B 23/285; G09B 23/30

(57) ABSTRACT

Disclosed are various embodiments for training physicians to perform surgeries or procedures. To do this, a display can render a three-dimensional model of human anatomy and a virtual surgical instrument in a virtual space. A computing device can receive movement input from an input device. Based on the movement input from the input device, the computing device can cause the virtual surgical instrument to move on the display. The computing device can detect a collision between the virtual surgical instrument and the three-dimensional model of human anatomy in the virtual space and, in response, the computing device can direct the input device to provide haptic feedback. Various other features are disclosed that further aid in the training of a surgeon to perform surgeries or procedures.

### CROSS-REFERENCE TO RELATED APPLICATIONS

This application claims priority to, and the benefit of, U.S. Provisional Patent Application 63/338,551, entitled “METHODS AND SYSTEMS FOR SURGICAL TRAINING,” which was filed on May 5, 2022 and is incorporated by reference as if set forth herein in its entirety.

### BACKGROUND

Training surgeons to perform a new surgery or procedure can be difficult, time consuming, and expensive. There are various of surgeries or procedures that are not performed laparoscopically or robotically for various reasons. Many of these surgeries or procedures that are not performed laparoscopically or robotically have a “blind” nature, wherein a surgeon inserts a tool or instrument into the human body and the surgeon must rely on external landmarks, a feel, pressure, or “push back” from the human anatomy.

These “blind” surgeries and procedures can be especially difficult and expensive to teach. New surgeons often learn procedures or surgeries on cadavers, which can be costly and do not provide certain responses that a living patient would typically provide, such as bleeding when an artery, vein, or other blood vessel is injured. Further, trained surgeons are required to take valuable hours from their busy operating schedules to train the new surgeons in these “blind” surgeries.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a computing environment according to various embodiments of the present disclosure.

FIG. 2 is a pictorial diagram of the computing environment of FIG. 1 according to various embodiments of the present disclosure.

FIG. 3 is a flowchart illustrating one example of functionality implemented as portions of an application executed in a computing environment of FIG. 1 according to various embodiments of the present disclosure.

FIG. 4 is a flowchart illustrating one example of functionality implemented as portions of an application executed in a computing environment of FIG. 1 according to various embodiments of the present disclosure.

FIG. 5 is a flowchart illustrating one example of an application on the computing device directing the display to render the virtual space, as recited in FIG. 4, according to various embodiments of the present disclosure.

FIG. 6 is a sequence diagram illustrating one example of the interactions between the components of the computing environment of FIG. 1 according to various embodiments of the present disclosure.

### DETAILED DESCRIPTION

Disclosed are various methods and systems for surgical training. Training surgeons to perform a new surgery or procedure can be difficult, time consuming, and expensive. Surgeries and procedures can be performed using various techniques. Some surgeries or procedures can be performed “open,” which directly exposes the affected anatomy to the open air, which provides high visibility to surgeon performing the surgery or procedure. For example, in open heart surgery, a surgeon cuts through the chest and breast bones to expose the heart. Some surgeries or procedures can be performed in a laparoscopic or robotic manner, which provide greater visibility on the human anatomy the surgery or procedure is being performed. For example, a laparoscopic or robotic appendectomy allows a surgeon to view the anatomy surrounding the abdomen up-close to remove the appendix more precisely as compared to performing the surgery open. Due to their highly visible nature, recordings of open, laparoscopic, and/or robotic surgeries or procedures can be shown as learning materials to teach new surgeons at a low cost.

However, there are many surgeries or procedures that are not performed open, laparoscopically, or robotically for various reasons (e.g., difficulty accessing the anatomy, not cost effective to utilize laparoscopic or robotic tools, etc.). Many of these surgeries or procedures that are not performed open, laparoscopically, or robotically can sometimes be performed in a “blind” nature, wherein a surgeon inserts a tool into the human body, relying primarily on the feel or “push back” from the human anatomy. One example of a surgery or procedure that is performed in a “blind” nature is placing a nasogastric tube (NG tube). To place an NG Tube, a physician must insert the tip of the tube into a patient's nose and continue pushing the tube along the floor of the nasal cavity until the tube passes into the patient's throat. The physician is unable to see the path of the tube as it is inserted, and the physician must entirely rely on the pressure or “push back” from the tube itself to ensure the proper insertion is occurring.

Another example of a “blind” surgery or procedure is implanting a retropubic sling trocar in the pelvis to aid urinary incontinence. This procedure is performed by inserting a retropubic sling trocar through a vaginal incision passing through a woman's pelvis until the retropubic sling trocar is positioned correctly. For this procedure, the surgeon relies on a pressure change or “push back” from various parts of the patient's anatomy to help guide the retropubic sling trocar to the correct placement. Certain anatomy may provide a stronger pressure or “push back” than other anatomy. For instance, the pelvic bone may feel incredibly hard and provide a strong pressure or “push back” response to the surgeon, whereas the periurethral fascia may provide a more subtle give, pressure, or “push back” response to the surgeon. This procedure can be incredibly difficult and dangerous for unskilled surgeons to perform due to nearby anatomy, such as various nerves, blood vessels and solid organs, like the bladder or bowel. An incorrect movement of the retropubic sling trocar by the surgeon can result in various complications, including neurovascular injury, bladder perforation, voiding dysfunction or mesh complications.

These “blind” surgeries and procedures can be especially difficult and expensive to teach. New surgeons often learn procedures or surgeries on cadavers. However, cadavers can be costly and do not provide certain responses that a living patient would typically provide, such as bleeding when an artery or blood vessel is injured. Further, trained surgeons are required to take valuable hours from their busy operating schedules to train the new surgeons in these “blind” surgeries. Without the trained surgeon present, the new surgeon may incorrectly blindly identify certain anatomy during the surgery or procedure, which could result in the new surgeon performing the surgery incorrectly on future patients.

The various embodiments of the present disclosure are directed to systems and methods used to train new surgeons how to perform surgeries and/or procedures. To do this, systems can be set up to perform a method of directing a display to render a three-dimensional model of human anatomy in a virtual space. The display can be directed to render a virtual surgical instrument in the virtual space. An input device can then receive movement input. Based on the movement input from the input device, the virtual surgical instrument can cause to move on the display. a collision can be detected between the virtual surgical instrument and the three-dimensional model of human anatomy in the virtual space. In response to detecting the collision of the virtual surgical instrument and the three-dimensional model of human anatomy in the virtual space, the input device can be directed to provide haptic feedback. Various other features may be disclosed that further aid in the training of a new surgeon to perform surgeries or procedures, or any surgeries or procedures which require certain training.

In the following discussion, a general description of the system and its components are provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

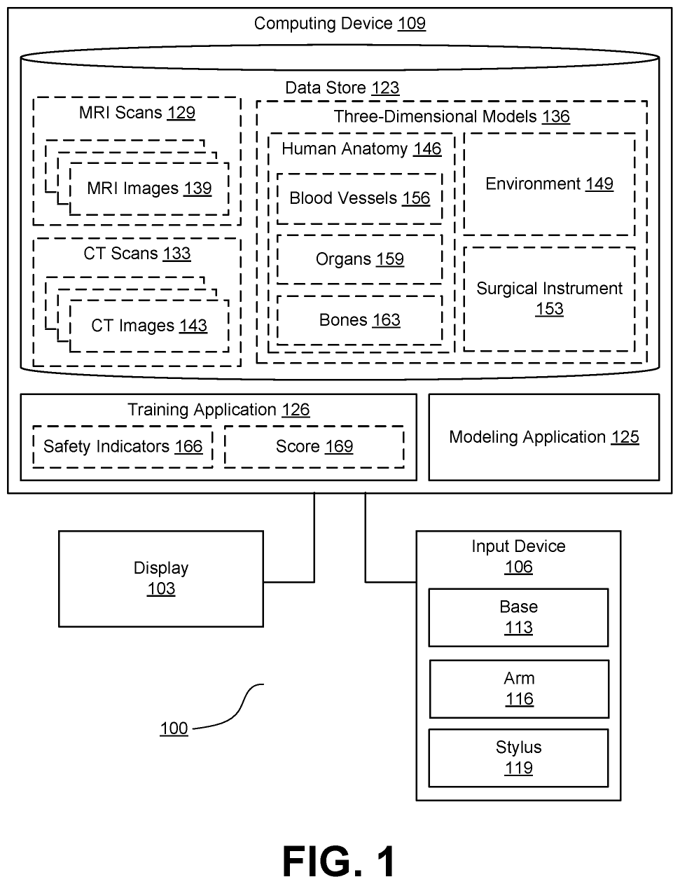

With reference to FIG. 1, shown is a computing environment 100 according to various embodiments. The computing environment 100 can include a display 103 (also referred to collectively as “displays 103” and generically as “a display 103”), an input device 106 (also referred to collectively as “input devices 106” and generically as “an input device 103”), and a computing device 109 (also referred to collectively as “computing devices 109” and generically as “a computing device 109”). The computing device 109 can be connected to both the display 103 and one or more input devices 106 by a wired connection or a wireless connection, or a combination thereof. Wired connections can include connecting via ethernet cables, Universal Serial Bus (USB) cables, fiber optic cables, or any connecting cable. The wired connection can also be part of a wired network. Wired networks can include Ethernet networks, cable networks, fiber optic networks, and telephone networks such as dial-up, digital subscriber line (DSL), and integrated services digital network (ISDN) networks. Wireless connections can include connecting over wireless networks, such as cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts.

The display 103 can include one or more displays 103, such as liquid crystal displays (LCDs), gas plasma-based flat panel displays, organic light emitting diode (OLED) displays, projectors, one or more headsets capable of augmented and/or virtual reality, or other types of display devices. In some embodiments, the display 103 can be a component of the computing device 109 or can be connected to the computing device 109 through a wired or wireless connection as previously mentioned. In at least some embodiments, the one or more displays 103 can include displays connected to a laptop, a tablet device, or a mobile device, such as a smart phone.

The input device 106 can be a human interactable device that measures and transmits three-dimensional movement data to a computing device 109 and provides haptic feedback to its operator. The input device 106 can measure three-dimensional movement in a variety of ways. In at least one embodiment, the input device 106 can include one or more gyroscopes. In at least some embodiments, the input device 106 can include one or more accelerometers. In some embodiments, the input device 106 can include one or more cameras capturing three-dimensional movement data. In some embodiments, the input device 106 can include using one or more passive infrared sensors (PIR sensors) to detect position of infrared light from one or more infrared light sources placed throughout a room. In such an embodiment, when the input device 106 detects the infrared light with the PIR sensors, the input device can calculate a relative distance, direction, and orientation of the input device 106.

The input device 106 can provide haptic feedback in a variety of ways. In at least one embodiment, the input device 106 can provide vibration. In some embodiments, the input device 106 can provide a resistance to move input device 106, often called force feedback. Various other ways to provide haptic feedback can be provided to the operator of the input device 106. In some embodiments, the input device 106 can provide haptic feedback in response to receiving instructions from the computing device 109. The received instructions can direct the input device 106 to perform each of the various forms of haptic feedback individually or concurrently. The received instructions can also provide values corresponding to additional parameters, such as feedback strength, duration, pattern, resistance direction, etc. These additional parameters, individually or in combination, can modify how the input device 106 can perform the haptic feedback. For example, an input device 106 can receive instructions to provide stronger haptic feedback when the input device 106 moves in a first direction and weaker haptic feedback when the input device 106 moves in a second direction.

In at least one embodiment, the input device 106 can be representative of a virtual reality glove that is capable of providing haptic feedback. In at least another embodiment, the input device 106 can be representative of a digital gaming control that is capable of providing haptic feedback. In at least another embodiment, the input device 106 can be a device that includes a base 113, an arm 116, and a stylus 119. The stylus 119 can be attached to the arm 116 and the arm 116 can be attached to the base 113. At least one example of this embodiment is the 3D Systems® Touch™ device or the 3D Systems® Touch X™ device.

The base 113 can remain on a surface while the entire input device 106 is in use. In one embodiment, the base 113 can be attached to a surface, such as a wall, a table, a counter, etc. Any suitable fastener can be used to attach the base to the surface. Examples of suitable fasteners include nails, screws, tape, glue, clamps, magnets, etc. In some embodiments, the base 113 can have a sufficient weight to remain on the surface while in use. At least one example of such an embodiment is shown in the 3D Systems® Touch™ device or the 3D Systems® Touch X™ device.

The arm 116 can include one or more elongated rods. At least one rod of the arm 116 can be attached to the base 113. In some embodiments, the arm 116 can include at least one of a first elongated rod and a second elongated rod. One end of the first elongated rod can be attached to the base and a second end of the first elongated rod can be pivotally attached to a first end of the second elongated rod. At least one example of this embodiment is shown in the 3D Systems® Touch™ device or the 3D Systems® Touch X™ device.

The stylus 119 can be an elongated structure having a first end and a second end. The stylus 119 can be pivotally attached to the arm 116 at any portion of the stylus 119. In at least one embodiment, the stylus 119 can be attached on the opposite side of the arm 116 as the base 113. In such an embodiment, the first end of the stylus 119 can be pivotally attached to the second end of the arm 116 so that the second end of the stylus 119 extends out and can freely move throughout three-dimensional space. At least one example of this embodiment is shown in the 3D Systems® Touch™ device or the 3D Systems® Touch X™ device.

The input device 106 can have various sensors to detect movement and orientation of the stylus 119 through three-dimensional space. In some implementations, micro-electromechanical sensors (MEMS) could be used, such as a MEMS gyroscope, MEMS accelerometer, MEMS speedometer or velocimeter, etc. For example, the stylus 119 can include one or more gyroscopic sensors that can detect the orientation (pitch, roll, yaw, etc.) of the stylus 119 while it is moved through three-dimensional space. The stylus 119 can also include one or more accelerometers that can detect the speed, force, intensity, and direction of the movements of the stylus 119 throughout three-dimensional space. At the connection point between the base 113 and the arm 116, there can be one or more sensors capable of measuring the angle between the base and the arm 116. Additionally, the arm 116 can include one or more sensors at the pivot point between two of the one or more rods. The sensor between the base 113 and the arm 116 in combination with any sensors in the arm 116, if the embodiment includes such sensors, can be used to determine the location of the stylus 119 relative to the base 113 in three-dimensional space. The combination of each of the aforementioned sensors can yield one or more values representing at least the location (x, y, z coordinates), the orientation (pitch, roll, yaw, etc.), and/or movement properties (speed, force, intensity, and direction of movement). The input device 106 can send the sensor data, such as the location, orientation, and movement properties, to the computing device 109 upon any movement that can be sensed by the aforementioned sensors.

The computing device 109 can include a data store 123, a modeling application 125, and a training application 126. Various data used by the modeling application 125 and the training application 126 can be stored in a data store 123 that can be accessible to the computing device 109. The data store 123 can be representative of a plurality of data stores 123, which can include relational databases or non-relational databases such as object-oriented databases, hierarchical databases, hash tables or similar key-value data stores, as well as other data storage applications or data structures. Moreover, combinations of these databases, data storage applications, and/or data structures can be used together to provide a single, logical, data store. The data stored in the data store 123 can be associated with the operation of the various applications or functional entities described below. This data can include Magnetic Resonance Imaging (MRI) scans 129, Computed Tomography (CT) scans 133, Three-dimensional Models 136 three-dimensional, and potentially other data.

MRI scans 129 are physician ordered image scans of a human body that are captured by magnetic resonance to capture detailed images of organs, tissues, blood vessels, and bones in the body. For the purpose of this application, an MRI scan 129 can be a collection of MRI images 139, each MRI image 139 depicting a two-dimensional slice of a body's organs, tissues, and other captured human anatomy. When the MRI images 139 of an MRI scan 129 are put together in their ordered sequence, a physician can perceive a three-dimensional perspective of the human body from the combination of the two-dimensional images. MRI scans 129 can be used to detect various medical issues. For example, MRI scans 129 can be used to detect brain and spinal cord anomalies, tumors and cysts, various cancers, joint injuries, certain types of heart problems, certain liver diseases, various abdominal organs, certain causes of pelvic pain in women like fibroids and endometriosis, certain uterine anomalies, and various other anatomical concerns. MRI scans 129 can capture MRI images 139 of various parts of human anatomy, such as bones, organs, tissues, and blood vessels, just to name a few. For example, an MRI scan 129 can capture MRI images 139 of a pelvic bone, blood vessels running through the pelvis, and various organs, like the bladder for example. The MRI scans 129 can be saved in a format readable by other computing devices, such as the Digital Imaging and Communications in Medicine (DICOM) format. The modeling application 125 can use the MRI scans 129 to generate three-dimensional models 136, as later described in this disclosure.

CT scans 133 are physician ordered image scans of a human body that are captured by x-rays to capture detailed images of organs, tissues, blood vessels, and bones in the body. For the purpose of this application, a CT scan 133 can be a collection of CT images 143, each CT image 143 depicting a two-dimensional slice of a body's organs, tissues, and other captured human anatomy. When the CT images 143 of a CT scan 133 are put together in their ordered sequence, a physician can perceive a three-dimensional perspective of the human body from the combination of the two-dimensional images. CT scans 133 can be used to detect various medical issues. For example, CT scans 133 can be used to detect brain and spinal cord anomalies, tumors and cysts, various cancers, joint injuries, certain types of heart problems, various abdominal organs, certain causes of pelvic pain in women like fibroids and endometriosis, certain uterine anomalies, and various other anatomical concerns. CT scans 133 can capture CT images 143 of various parts of human anatomy, such as bones, organs, tissues, and blood vessels, just to name a few. For example, a CT scan 133 can capture CT images 143 of a pelvic bone, blood vessels running through the pelvis, and various organs, like the bladder for example. The CT scans 133 can be saved in a format readable by other computing devices, such as the Digital Imaging and Communications in Medicine (DICOM) format. The modeling application 125 can use the CT scans 133 to generate three-dimensional models 136, as later described in this disclosure.

The data store 123 can also store three-dimensional models 136 that can be rendered by the display 103 to demonstrate a three-dimensional simulation. The three-dimensional models 136 can be stored in various formats, such as stereolithography (.STL) format, Wavefront 3D Object (.OBJ) format, Autodesk Filmbox (.FBX) format, Autodesk 3D Studio (.3DS) format, AutoCAD Drawing (.DWG) format, AutoCAD Drawing Exchange (.DXF) format, Collada Digital Asset Exchange (.DAE) format, Standard for the Exchange for Product Data (.STEP) format, Xara 3D Maker (.X3D) format, Additive Manufacturing File (.AMF) format, 3D Manufacturing File (.3MF) format, or any other formats for modeling three-dimensional objects. Each three-dimensional model 136 can include boundaries, also called a mesh, which defines its three-dimensional shapes. These three-dimensional models 136 can also include a surface appearance, defined by a texture map, which overlays the mesh to provide the otherwise textureless, colorless mesh with one or more textures and/or one or more colors. In at least one embodiment, the data store 123 can store three-dimensional models 136 corresponding to human anatomy 146, an environment 149, and surgical instruments 153.

The three-dimensional models 136 for human anatomy 146 can include three-dimensional models 136 for a blood vessel 156, an organ 159, and a bone 163. For the purposes of this disclosure, organs 159 can also include body tissues, such as fascia, muscles, and nerves. The three-dimensional models 136 for human anatomy 146 can be generated by the modeling application 125 based on one or more MRI scans 129 and/or CT scans 133. Each of these three-dimensional models 136 for blood vessels 156, organs 159, and bones 163 can include boundaries, also called a mesh, which defines its three-dimensional shapes. Each of these three-dimensional models 136 for blood vessels 156, organs 159, and bones 163 can also include a surface appearance, defined by a texture map, which overlays the mesh to provide the otherwise textureless, colorless mesh with one or more textures and/or one or more colors.

In many embodiments, each of these three-dimensional models 136 for blood vessels 156, organs 159, and bones 163 can resemble their respective human anatomy as they would exist in a human body. For example, the three-dimensional model 136 of a blood vessel 156 can represent one or more of the femoral arteries, the femoral veins, the iliac arteries, the iliac veins, the uterine arteries, the uterine veins, or any other artery or vein within the human body. In another example, the three-dimensional model 136 of an organ 159 can represent one or more of the uterus, the bladder, the colon, the liver, the kidneys, or other organs of the human body. In another example, the three-dimensional model 136 of a bone 163 can represent one or more of the uterus, the bladder, the colon, the liver, the kidneys, or other organs of the human body. Each of these three-dimensional models 136 for blood vessels 156, organs 159, and bones 163 can also include additional information that can later be used in the training application 126, such as hardness or pressure strength. This additional information can have different values for hardness or pressure strength at different places among its respective three-dimensional model 136; those values can be stored corresponding to certain locations along boundaries or mesh of the three-dimensional model 136.

In at least one embodiment, the three-dimensional model 136 of the human anatomy 146 includes blood vessels 156, organs 159, and bones 163. Such an embodiment can include specific blood vessels 156 that traverse the pelvis; an organ 159, such as the bladder; and bones 163, such as the pelvic bones. This combination of three-dimensional models 136 of human anatomy 146 can be used by the training application 126 to virtualize a retropubic sling surgery or any surgery performed in the pelvis. The three-dimensional model 136 of the human anatomy 146 includes blood vessels 156, organs 159, and bones 163 can be rendered or assist in rending by using Artificial Intelligence (AI). AI and AI assisted annotation and segmentation can speed up and automate the annotation and segmentation process while saving time and increasing productivity. Different AI algorithms can further capitalize on deep learning techniques, such as transfer learning, to optimize the accuracy of the annotation process.

The three-dimensional models 136 can also include an environment 149. The three-dimensional models 136 for an environment 149 can include a model of a room or more specifically, an operating room. The three-dimensional models 136 for an environment 149 can have additional models of common equipment found in an operating room, such as one or more operating tables or one or more patient health monitors. The three-dimensional models 136 of the environment 149 can be used to acclimate a new surgeon to performing this surgery or procedure in the real world by mimicking a real-world scenario of performing the procedure or surgery. In at least one embodiment, the three-dimensional model 136 for the environment 149 can include boundaries, also called a mesh, which define its three-dimensional shapes. The three-dimensional model 136 for the environment 149 can also include a surface appearance, defined by a texture map, which overlays the mesh to provide the otherwise textureless, colorless mesh with one or more textures and/or one or more colors. In at least one embodiment, the three-dimensional models 136 for an environment 149 resembles an operating room. In at least another embodiment, no three-dimensional model 136 for the environment 149 will have been rendered. In at least another embodiment, a simple three-dimensional model 136 for the environment 149 will have been rendered, comprising at least one of a color, pattern, or shading for a virtual space.

The three-dimensional models 136 can also include a surgical instrument 153. The three-dimensional model 136 for the surgical instrument 153 can resemble real world surgical instruments used in a specified surgery. For example, the three-dimensional model 136 for the surgical instrument 153 can resemble a scalpel, a trocar, a tube, or any other tool used to perform a specified surgery. In at least one embodiment, the three-dimensional model 136 for the surgical instrument 153 can include boundaries, also called a mesh, which define its three-dimensional shapes. The three-dimensional model 136 for the surgical instrument 153 can also include a surface appearance, defined by a texture map, which overlays the mesh to provide the otherwise textureless, colorless mesh with one or more textures and/or one or more colors. The three-dimensional model 136 for the surgical instrument 153 can also include additional information that can later be used in the training application 126, such as hardness and/or flexibility.

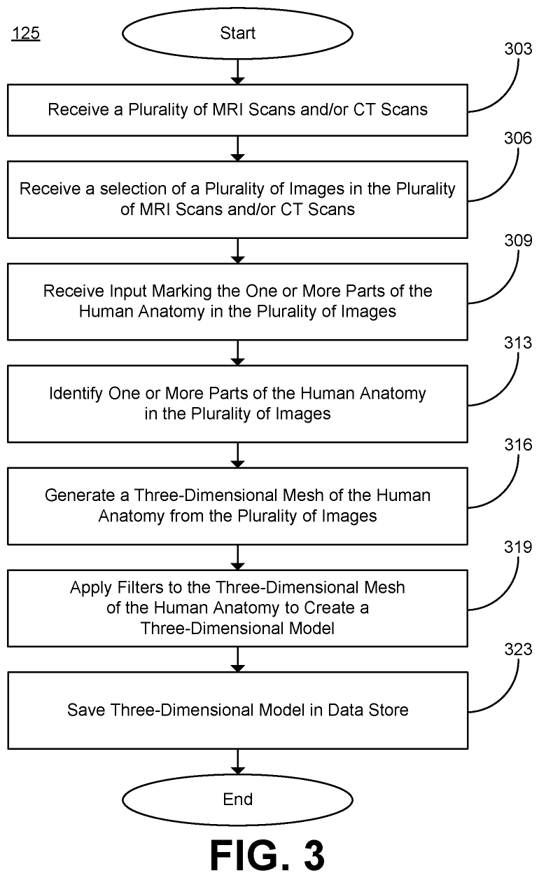

The modeling application 125 can represent an application that, when executed, can generate three-dimensional models 136 of human anatomy 146 from MRI scans 129 and/or CT scans 133. This process is further disclosed in FIG. 3. The modeling application 125 can receive MRI scans 129 and/or CT scans 133 from the data store 123. The modeling application 125 can also store three-dimensional models 136 of human anatomy 146 in the data store 123 for use by the training application 126.

The training application 126 can be an application that, when executed, coordinates surgical training by utilizing the computing device 109, the display 103, and the input device 106. The training application 126 can access the data store 123 on the computing device 109 to use for various purposes later described in this specification.

The training application 126 can direct the display to render three-dimensional models 136 stored in the data store 123, including the human anatomy 146, such as blood vessels 156, organs 159, and bones 163; the environment 149; and one or more surgical instruments 153. To do this, the training application 126 can load the three-dimensional models 136 into memory and calculate a specific virtual location for where the three-dimensional models 136 should be rendered in a virtual space. The virtual location of where the three-dimensional models 136 can be used to generate one or more images, which can be rendered on the display 103.

The training application 126 can receive the sensor data, such as the location, orientation, and movement properties, from the input device 106. Using the sensor data from the input device 106, the training application 126 can direct one or more three-dimensional models 136 to move in the virtual space, as rendered by the display 103. For instance, upon receiving the sensor data from the input device 106, the training application 126 can calculate the movement of a surgical instrument 153 in the virtual space and direct the display 103 to render a series of images demonstrating the movement of the surgical instrument 153.

The training application 126 can detect collisions between one or more of the three-dimensional models 136 in the virtual space. To do this, the training application 126 can calculate whether the three-dimensional models 136 intersect on any plane of their mesh. For example, the training application 126 can have calculated a virtual space having an environment 149, a bone 163, and a surgical instrument 153 which can be rendered by the display 103. Upon receiving the sensor data from the input device 106, the surgical instrument 153 would move through the virtual space. However, the training application 126 can detect when the surgical instrument 153 intersects with the bone 163 in the virtual space and recognize this intersection as a collision between the surgical instrument 153 and the bone 163.

Upon collision, the training application 126 can direct the display to render the virtual space so the intersection of the three-dimensional models 136 does not occur. The training application 126 can do this by moving at least one of the three-dimensional models 136 to a non-intersecting location in the virtual space. Additionally, upon collision, the training application 126 can direct the input device 106 to provide haptic feedback to the user. In at least one embodiment, the training application 126 can direct the input device to provide vibration. In another embodiment, the training application 126 can direct the input device 106 to provide a resistance to moving the input device 106, often called force feedback. The training application 126 can provide the input device 106 with instructions on how to perform the haptic feedback, such as feedback strength, duration, pattern, resistance direction, etc. For example, the training application 126 can direct the input device 106 to provide stronger haptic feedback when the training application 126 detects a collision between a surgical instrument 153 and a bone 163 and weaker haptic feedback when the training application 126 detects a collision between a surgical instrument 153 and an organ 159. The various configurations of how to perform the haptic feedback can correlate to the various three-dimensional models 136 of human anatomy 146.

The training application 126 can also calculate and render one or more safety indicators 166. A safety indicator 166 can be used to track or display whether a collision between a surgical instrument 153 and a three-dimensional model 136 of human anatomy 146 has occurred. Additionally, a safety indicator 166 can track the distances between the surgical instrument 153 and three-dimensional model 136 of the human anatomy 146. If the distance between the surgical instrument 154 and the three-dimensional model 136 of the human anatomy 146 reaches zero, then a collision has occurred. In at least some embodiments, the safety indicator 166 can be used to indicate a warning that the distance between the surgical instrument 154 and the three-dimensional model 136 of the human anatomy 146 is negligible. The training application 126 can further use AI models in the calculation used for safety indicators 166. In at least one embodiment, an AI model can track the movement of surgical instruments 153 and any collision information corresponding to the surgical session to adjust any scoring criteria or warning distances for the safety indicators 166. Accordingly, the AI models of the training application 126 can improve from various surgeons over time as a result of the cumulation of surgical data. In time, a model can learn the correct and incorrect actions of one or more surgeons and the AI model can better guide surgeon behavior. The values of the safety indicators 166 can be rendered on the display 103. In at least some embodiments, the values of the safety indicators 166 can be rendered along with the corresponding human anatomy 146 related to the safety indicator 166.

The safety indicator 166 can maintain various values. In at least one embodiment, the safety indicators 166 can demonstrate whether the human anatomy 146 is safe or unsafe from collision with the surgical instrument 153. In such an embodiment, a collision could occur between the human anatomy 146 and the surgical instrument 153, the safety indicator 166 can persist or display the value “unsafe” because such a collision has already occurred. In at least another embodiment, the safety indicators 166 can demonstrate the distance between the human anatomy 146 and the surgical instrument 153. In some embodiments, certain three-dimensional models 136 of human anatomy 146 can be configured to provide haptic feedback upon collision with the surgical instrument 153 because there can be an allocated “safe amount” of collision that can occur to the human anatomy 146. In such an embodiment, the safety indicator 166 can show one of a safe/unsafe value and/or a distance to remain safe value while actively colliding with the human anatomy 146. The distances can be shown as a numerical distance with a unit of measurement (feet, inches, centimeters, millimeters, etc.) or as a percentage of remaining safe distance (10%, 15%, etc.).

The training application 126 can also calculate and render a score 169. The score 169 can be calculated based on a variety of factors, such as patient safety, time to complete the surgery, proper technique, final placement of a device, and various other factors. The score 169 can be rendered on the display 103 so a surgeon can track their progress and/or recognize how they are performing during the virtual procedure or surgery. The score 169 can also be used as an evaluation metric to indicate to a school, hospital, and/or medical facility that the surgeon is competent (or does not understand) to perform the procedure or surgery.

When the training application 126 begins, the score 169 can be set at a default value (100%, 0, etc.). While performing the procedure, the training application 126 can increase or decrease the score 169 based on various events that can occur, such as collisions or taking too long to complete a step in the procedure. In one embodiment, a score 169 starts at 100% and the score 169 can receive a small deduction based on a collision between the surgical instrument 153 and a less fragile structure, like a bone 163. The score 169 can also receive a moderate deduction based on a collision between the surgical instrument 153 and a fragile structure, like an organ 159. The score 169 can also receive a large deduction based on a collision between the surgical instrument 153 and a critical structure, such as a blood vessel 156. In at least one embodiment the In at least another embodiment, a score 169 can start at 0 and the score 169 can be increased when the new surgeon follows a specified path to perform the procedure with the input device 106.

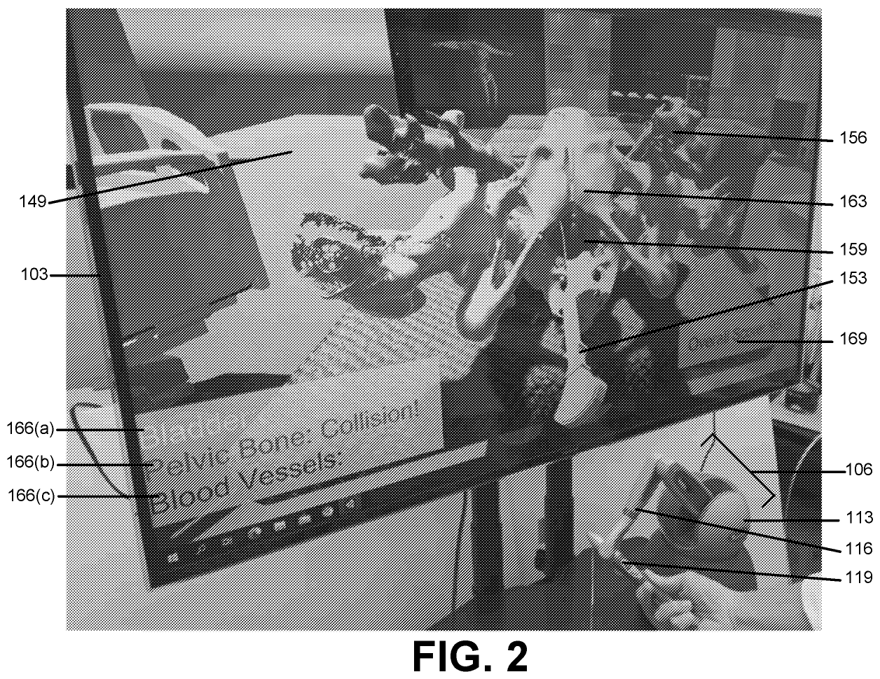

Referring next to FIG. 2, shown is an example system for training a surgical procedure as demonstrated in FIG. 1. FIG. 2 demonstrates a display 103, such as a LED or LCD television or computer monitor. The display 103 can rendering various three-dimensional models 136, such an environment 149, a surgical instrument 153, one or more blood vessels 156, one or more organs 159, and one or more bones 163.

The three-dimensional model 136 of the environment 149 shown in FIG. 2 is an example of a virtual operating room. The virtual operating room has an operating table, the patient's bed, a floor, walls, and various room decorations. The environment 149 in FIG. 2 helps situate the surgeon in the virtual space and better understand how the display can be situated with respect to a typical operating room setup.

The three-dimensional model 136 of the surgical instrument 153 shown in FIG. 2 is a virtual retropubic sling trocar. The virtual retropubic sling trocar mimics the look of a real world retropubic sling trocar in shape and size. Although the virtual retropubic sling trocar is shown in a specific shape, color, and size, it should be understood that various shapes, colors, and sizes of sling trocars could be used as the surgical instrument 153. In fact, various brands of surgical instruments 153 can be generated as three-dimensional models 136 of surgical instruments 153 if the features of the specific brand of surgical instrument differ from a standard three-dimensional model 136.

Various examples of three-dimensional models 136 of human anatomy 146, such as blood vessels 156, organs 159, and bones 163 are shown in FIG. 2. As shown in FIG. 2, the three-dimensional models 136 of human anatomy 146 rendered by the display does not need to include every blood vessel 156, organ 159, or bone 163 in a human body. Relevant human anatomy 146 can be chosen for specific surgeries to not complicate the training. As depicted in FIG. 2, the blood vessels 156 are a virtual representation of the iliac arteries, the organ 159 is a virtual representation of a bladder, and the bones 163 depicted are a virtual representation of pelvic bones.

The display 103 of FIG. 2 also renders safety indicators 166a-c (also referred to collectively as “safety indicators 166” and generically as “a safety indicator 166”). Each of the safety indicators 166a-c can be rendered as a name of the human anatomy and a respective safety indicator value. A first safety indicator 166a can have a name of the human anatomy, for example, the “bladder,” and the first safety indicator's 166a value can be shown as a percentage value that indicates the remaining margin of safety before puncturing the human anatomy 146. A second safety indicator 166b can have a name of the human anatomy, for example, the “pelvic bone,” and the safety indicator's 166b value can be “Collision!”, which indicates that the surgical instrument 153 is colliding with the corresponding human anatomy. A third safety indicator 166c can have a name of the human anatomy, for example, “blood vessels,” and the safety indicator's 166c value can be blank.

The display 103 of FIG. 2 also renders the score 169. The score comprises the words “Overall Score,” followed by a score value, represented by the value “ninety-five” in FIG. 2.

FIG. 2 also demonstrates at least one example of a user interacting with an input device 106. FIG. 2 depicts the input device 106 as a 3D Systems® Touch™ device. The 3D Systems® Touch™ device has a base 113, arm 116, and a stylus 119 as previously described. FIG. 2 also depicts a user handing the stylus 119 of the input device 106. Any movement made by the user that handles the stylus 119 could be captured by the sensors of the input device 106 and sent to the training application 126, which in turn moves the surgical instrument 153 on the display. Because FIG. 2 depicts the safety indicator 166b value of “collision,” the training application 126 can direct the input device 106 to provide haptic feedback if the user continues to collide the surgical instrument 153 with the bone 163.

Referring next to FIG. 3, shown is a flowchart that provides one example of the operation of the modeling application 125. The flowchart of FIG. 3 provides merely an example of the many different types of functional arrangements that can be employed to implement the operation of the depicted portion of the modeling application 125. Alternatively, the flowchart of FIG. 3 could be viewed as depicting a method implemented by the computing device 109.

Beginning with block 303, the modeling application 125 can receive a plurality of MRI scans 129 and/or CT scans 133. The modeling application 125 can receive the plurality of MRI scans 129 and/or CT scans 133 from another device or from a network connection. The MRI scans 129 and/or CT scans 133 can be stored on the data store 123, which can be accessed by the modeling application 125. The MRI scans 129 and/or CT scans 133 can include a plurality of MRI images 139 or a plurality of CT images 143, respectively. For example, a received MRI scan 129 can include one hundred MRI images 139 in sequential order.

At block 306, the modeling application 125 can receive a selection a plurality of MRI images 139 of the MRI scans 129 and/or CT images 143 of the CT scans 133 stored in the data store 123. The selection of the plurality of the MRI images 139 and the CT images 143 can depict such cross sections of the human anatomy, such as bones, organs, tissues and blood vessels, just to name a few. The selection of the plurality of the MRI images 139 and the CT images 143 can be chosen to limit the overall number of MRI images 139 and CT images 143 to be processed by the modeling application 125 to generate three-dimensional models 136. For example, in an MRI scan 129 that includes one hundred MRI images 139, the computing device can receive a selection of ten of the one hundred MRI images 139.

At block 309, the modeling application 125 can receive input markings for the one or more parts of the human anatomy in the selection of the plurality of MRI images 139 and/or CT images 143. These received input markings can cover or outline a portion of human anatomy depicted in the plurality of the MRI images 139 and/or the CT images 143. For example, in the selected MRI images 139 from block 306, the markings can outline a portion of human anatomy, such as the bladder, on each of the ten MRI images 139.

At block 313, the modeling application 125 can identify a part of the human anatomy in the non-selected MRI images 139 and/or CT images 143 based on the input marking the selection of the plurality of the MRI images 139 and/or CT images 143. The input markings can establish the boundaries of a part of the human anatomy. The modeling application 125 can use machine learning models to identify the marked anatomy in pictures that did not receive input marking. As such, the modeling application 125 extrapolates a selection of the appropriate human anatomy from non-selected MRI images 139 and/or CT images 143. For example, the modeling application 125 can identify the bladder in all of the MRI images 139 of an MRI scan 129 based on the input markings of the selected MRI images 139.

At block 316, the modeling application 125 can generate a three-dimensional model of the human anatomy from the plurality of the MRI images 139 and/or CT images 143. Using all of the MRI images 139 and/or CT images 143 that have the identified human anatomy, the modeling application 125 can make a mesh from the ordered sequence of the respective images. The modeling application 125 can do this by excluding portions of the MRI images 139 and/or CT images 143 that do not identify the selected anatomy. Then the MRI images 139 and/or CT images 143 can be placed in their ordered sequence to create a mesh or three-dimensional outlines of the human anatomy. For example, the portions of the MRI images 139 that do not depict the bladder can be removed, leaving only the bladder. When the MRI images 139 are subsequently sequenced in the appropriate order, the borders or boundaries of bladder can be determined to create a three-dimensional mesh. Additionally, the modeling application 125 can use various algorithms, such as a “grow-from-seeds” algorithm to generate the additional three-dimensional model of the human anatomy from the plurality of the MRI images 139 and/or CT images 143.

At block 319, the modeling application 125 can apply filters to the three-dimensional mesh of the human anatomy to create a three-dimensional model 136 of the human anatomy 146. In at least one embodiment, the modeling application 125 can apply a gaussian blur to the model to smooth the three-dimensional mesh. Other filters can be used to enhance or simplify the three-dimensional mesh. Once the filters have been applied to the three-dimensional mesh, the three-dimensional mesh becomes a three-dimensional model 136 of the human anatomy 146.

At block 323, the modeling application 125 can store the three-dimensional model 136 of the human anatomy 146 in the data store 123. The three-dimensional models 136 can be stored in various formats, such as stereolithography (.STL) format, Wavefront® 3D Object (.OBJ) format, Autodesk® Filmbox (.FBX) format, Autodesk® 3D Studio (.3DS) format, AutoCAD® Drawing (.DWG) format, AutoCAD® Drawing Exchange (.DXF) format, Collada® Digital Asset Exchange (.DAE) format, Standard for the Exchange for Product Data (.STEP) format, Xara® 3D Maker (.X3D) format, Additive Manufacturing File (.AMF) format, 3D Manufacturing File (.3MF) format, or any other formats for modeling three-dimensional objects. Upon storing the three-dimensional model 136 of the human anatomy 146 in the data store 123, the method displayed in FIG. 3 can come to an end.

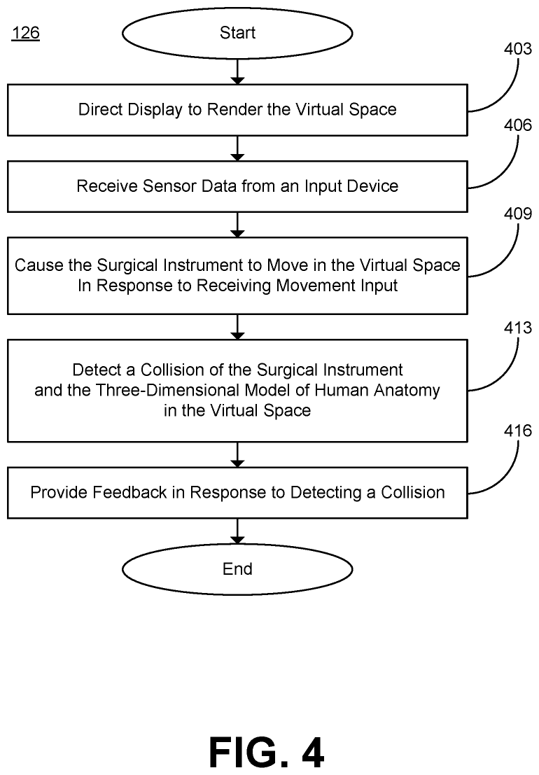

Referring next to FIG. 4, shown is a flowchart that provides one example of the operation of the training application 126. The flowchart of FIG. 4 provides merely an example of the many different types of functional arrangements that can be employed to implement the operation of the depicted portion of the training application 126. Alternatively, the flowchart of FIG. 4 could be viewed as depicting a method implemented by the computing device 109.

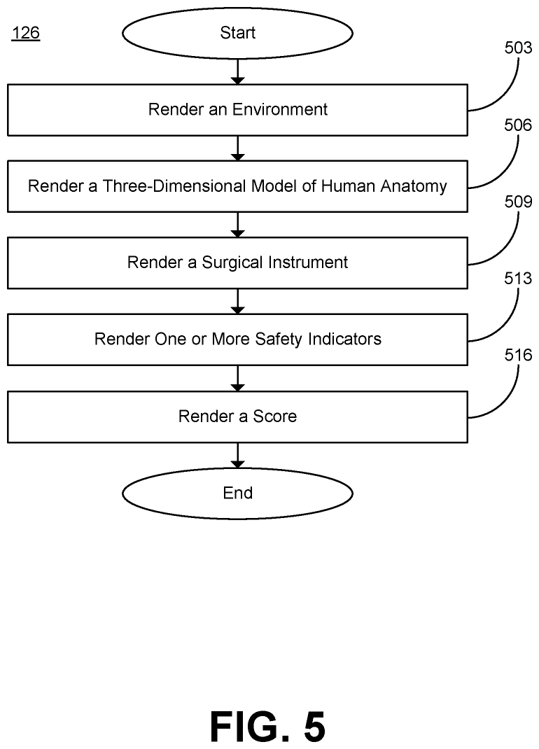

Starting at block 403, the training application 126 can direct the display 103 to render the virtual space. In at least one embodiment, the training application 126 can direct the display 103 to render various three-dimensional models 136 from the data store 123, including an environment 149, human anatomy 146, and a surgical instrument 153. This step can also be performed as depicted in the method of FIG. 5, as later described. In some embodiments, prior to rendering the virtual space on the display, instructions of how to use the system can be shown and/or an instructional video can be played which depicts an example of the surgery being performed.

In block 406, the training application 126 on the computing device 109 can receive sensor data from an input device 106. As previously disclosed, the sensors of the input device 106 can ultimately yield one or more values representing at least the location (x, y, z coordinates), the orientation (pitch, roll, yaw, etc.), and/or movement properties (speed, force, intensity, and direction of movement), which collectively yield sensor data. The training application 126 can receive this sensor data from the input device 106.

In block 409, the training application 126 can cause the surgical instrument 153 to move in the virtual space. The training application 126 can calculate movements for the surgical instrument 153 corresponding to the received sensor data from the input device 106. The training application 126 can then direct the display 103 to render the calculated movements.

In block 413, the training application 126 can detect a collision between the surgical instrument 153 and the three-dimensional model 136 of human anatomy 146. To do this, the training application 126 can calculate whether the three-dimensional models 136 intersect on any plane of their respective meshes. For example, the training application 126 can generate a virtual space having an environment 149, a bone 163, and a surgical instrument 153, each of which can be rendered by the display 103. Upon receiving the sensor data from the input device 106, the surgical instrument 153 can move through the virtual space. The training application 126 can detect when the surgical instrument 153 intersects with the bone 163 in the virtual space. The training application 126 can recognize an intersection between the surgical instrument 153 and the bone as a collision.

In block 416, the training application 126 can provide feedback to the user in response to detecting a collision. Upon collision, the training application 126 can direct the input device 106 to provide haptic feedback to the user. In at least one embodiment, the training application 126 can direct the input device to provide vibration. In another embodiment, the training application 126 can direct the input device 106 to provide a resistance to moving the input device 106, often called force feedback. The training application 126 can provide the input device 106 with instructions on how to perform the haptic feedback, such as feedback strength, duration, pattern, resistance direction, etc. For example, the training application 126 can direct the input device 106 to provide stronger haptic feedback when the training application 126 detects a collision between a surgical instrument 153 and a bone 163 and weaker haptic feedback when the training application 126 detects a collision between a surgical instrument 153 and an organ 159. The various configurations of how to perform the haptic feedback can correlate to the various three-dimensional models 136 of human anatomy 146.

The training application 126 can provide feedback by calculating and causing the display to render one or more updated safety indicators 166 in response to detecting a collision. The safety indicator 166 can indicate whether a collision between a surgical instrument 153 and a three-dimensional model 136 of human anatomy 146 has occurred. Additionally, a safety indicator 166 can track a distance between the three-dimensional model 136 of the human anatomy 146 and the surgical instrument 153. Based on the distance, the training application 126 can determine that a collision has occurred. The safety indicator 166 can maintain various values. In at least one embodiment, the safety indicators 166 can demonstrate whether the human anatomy 146 is safe or unsafe from collision with the surgical instrument 153. In such an embodiment, if there is a collision between the human anatomy 146 and the surgical instrument 153, the safety indicator 166 can persist the value “unsafe” or “collision” because the collision had already occurred.

The training application 126 can also provide feedback by calculating and/or causing the display to render an updated score 169. The score 169 can be calculated based on a variety of factors, such as patient safety, time to complete the surgery, proper technique, final placement of a device, and various other factors. While performing the procedure, the training application 126 can increase or decrease the score 169 based on various events that can occur, such as collisions. In one embodiment, a score 169 starts at 100% and the score 169 can receive a small deduction based on a collision between the surgical instrument 153 and an organ 159. The score 169 can receive an additional, greater deduction based on a collision between the surgical instrument 153 and the blood vessels 156. All the data collected during the process of FIG. 4 can be stored in a data store 123. The data collected can then be used to further improve upon the system in various ways. Upon providing feedback in response to detecting a collision, the method displayed in FIG. 4 comes to an end.

Referring next to FIG. 5, shown is an example method for directing the display 103 to render the virtual space, as recited in block 403 of FIG. 4. The flowchart of FIG. 5 continues to provide merely an example of the many different types of functional arrangements that can be employed to implement the operation of the depicted portion of the training application 126. Alternatively, the flowchart of FIG. 5 could be viewed as depicting a method implemented by the computing device 109.

Beginning at block 503, the training application 126 can direct the display 103 to render a three-dimensional model 136 of the environment 149. In at least one embodiment, the three-dimensional models 136 for an environment 149 resembles an operating room. In at least another embodiment, a simple three-dimensional model 136 for the environment 149 can be rendered, including at least one of a color, pattern, or shading for a virtual space. The three-dimensional models 136 for an environment 149 could have additional models of common equipment found in an operating room, such as one or more operating tables or one or more patient health monitors.

At block 506, the training application 126 can direct the display 103 to render a three-dimensional model 136 of human anatomy 146. The three-dimensional models 136 for human anatomy 146 can include three-dimensional models 136 for blood vessels 156, organs 159, and bones 163. In many embodiments, each of these three-dimensional models 136 for blood vessels 156, organs 159, and bones 163 can resemble their respective human anatomy as they would exist in a human body. For example, the three-dimensional model 136 of a blood vessel 156 can represent one or more of the femoral arteries, the femoral veins, the iliac arteries, the iliac veins, the uterine arteries, the uterine veins, or any other artery or vein within the human body. In another example, the three-dimensional model 136 of an organ 159 can represent one or more of the uterus, the bladder, the colon, the liver, the kidneys, or other organs of the human body. In another example, the three-dimensional model 136 of a bone 163 can represent one or more of the uterus, the bladder, the colon, the liver, the kidneys, or other organs of the human body. In at least one embodiment, the three-dimensional models 136 for human anatomy 146 can include specific blood vessels 156 that traverse the pelvis; an organ 159, such as the bladder; and bones 163, such as the pelvic bones. This combination of three-dimensional models 136 of human anatomy 146 can be used by the training application 126 to virtualize a retropubic sling surgery or any surgery performed in the pelvis.

In block 509, the training application 126 can direct the display 103 to render a three-dimensional model 136 of a surgical instrument 153. The three-dimensional model 136 for the surgical instrument 153 can resemble real world surgical instruments used for various surgeries. For example, the three-dimensional model 136 for the surgical instrument 153 can resemble a scalpel, a trocar, a tube, or any other tool used to perform a surgery. In at least one embodiment, the surgical instrument 153 can resemble a retropubic sling trocar.

In block 513, the training application 126 can direct the display 103 to render a three-dimensional model 136 of one or more safety indicators 166. A safety indicator 166 can be used to track whether a collision between a surgical instrument 153 and a three-dimensional model 136 of human anatomy 146 has occurred. Additionally, a safety indicator 166 can track the distance between the three-dimensional model 136 of the human anatomy 146 and surgical instrument 153. The values of the safety indicators 166 can be rendered on the display 103 with the corresponding human anatomy 146 related to the safety indicator 166. The safety indicator 166 can maintain various values. In at least one embodiment, the safety indicators 166 can demonstrate whether the human anatomy 146 is safe or unsafe from collision with the surgical instrument 153. In such an embodiment, if a collision occurs between the human anatomy 146 and the surgical instrument 153, the safety indicator 166 can persist the value “unsafe” because the collision had already occurred. in at least another embodiment, the safety indicators 166 can demonstrate the distance between the human anatomy 146 and the surgical instrument 153. In some embodiments, certain three-dimensional models 136 of human anatomy 146 can be configured to provide haptic feedback upon collision and there can be a safe amount of collision that can occur to the human anatomy 146. In such an embodiment, the safety indicator 166 can show one of a safe/unsafe value or a distance to remain safe value while actively colliding with the human anatomy 146. The distances can be shown as a numerical distance with a unit of measurement (feet, inches, centimeters, millimeters, etc.) or as a percentage of remaining safe distance (10%, 15%, etc.). The one or more safety indicators 166 can be rendered in various locations on the display 103. In at least one embodiment, the safety indicators 166 can be rendered in the bottom left portion of the display 103, away from the three-dimensional models 136 of human anatomy 146.

In block 516, the training application 126 can direct the display 103 to render a three-dimensional model 136 of one or more safety indicators 166. The score 169 can be rendered on the display 103 so a surgeon can track their progress and/or recognize how they are performing during the virtual procedure or surgery. When the training application 126 begins, the score 169 can be set at a default value (100%, 0, etc.). While performing the procedure, the training application 126 can increase or decrease the score 169 based on various events that can occur, such as collisions or taking too long to complete a step in the procedure. In one embodiment, a score 169 starts at 100% and the score 169 can receive a small deduction based on a collision between the surgical instrument 153 and an organ 159. The score 169 can receive an additional, greater deduction based on a collision between the surgical instrument 153 and the blood vessels 156. In at least another embodiment, a score 169 can start at 0 and the score 169 can be increased when the new surgeon follows a specified path to perform the procedure with the input device 106. The score 169 can be rendered in various locations on the display 103. In at least one embodiment, the score 169 can be rendered in the bottom right portion of the display 103, away from the three-dimensional models 136 of human anatomy 146. After block 516, the method of FIG. 5 ends.

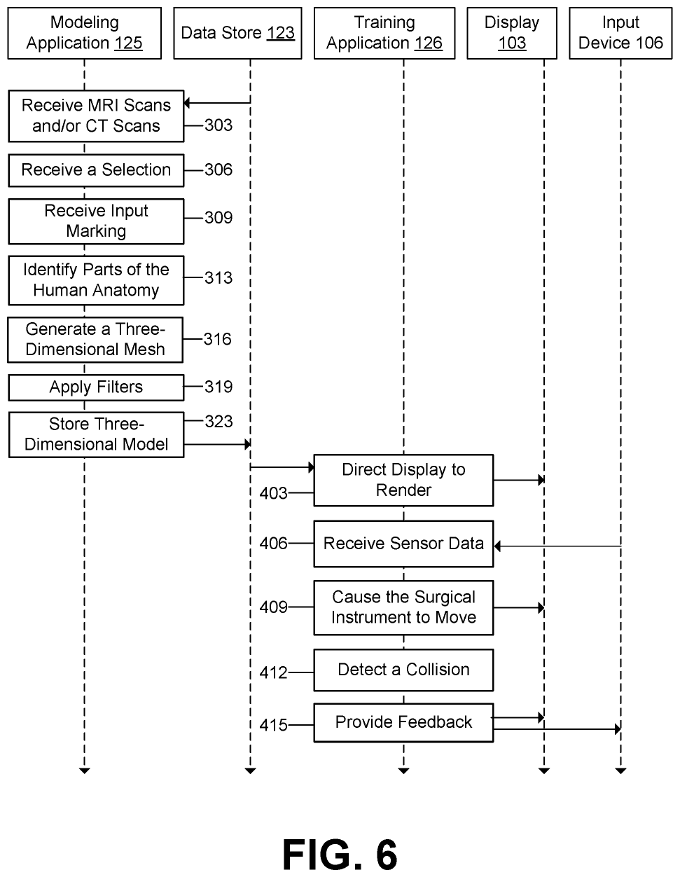

Referring next to FIG. 6, shown is a sequence diagram that illustrates the interactions between the modeling application 125, the data store 123, the training application 126, the display 103, and the input device 106. The sequence diagram of FIG. 6 provides merely an example of the many different types of functional arrangements that can be employed to implement the operation of the depicted portion between the modeling application 125, the data store 123, the training application 126, the display 103, and the input device 106. As an alternative, the sequence diagram of FIG. 6 can be viewed as depicting an example of elements of a method implemented in the computing environment 100.

To begin, the modeling application 125 can receive a plurality of MRI scans 129 and/or CT scans 133, as previously described in the discussion of block 303 of FIG. 3. Next, the modeling application 125 can receive a selection a plurality of MRI images 139 of the MRI scans 129 and/or CT images 143 of the CT scans 133 stored in the data store 123, as previously described in the discussion of block 306 of FIG. 3. Next, the modeling application 125 can receive input markings for the one or more parts of the human anatomy in the selection of the plurality of MRI images 139 and/or CT images 143, as previously described in the discussion of block 309 of FIG. 3. Next, the modeling application 125 can identify a part of the human anatomy in the non-selected MRI images 139 and/or CT images 143 based on the input markings the selection of the plurality of the MRI images 139 and/or CT images 143, as previously described in the discussion of block 313 of FIG. 3. Next, the modeling application 125 can generate a three-dimensional model of the human anatomy from the plurality of the MRI images 139 and/or CT images 143, as previously described in the discussion of block 316 of FIG. 3. Next, the modeling application 125 can apply filters to the three-dimensional mesh of the human anatomy to create a three-dimensional model 136 of the human anatomy 146, as previously described in the discussion of block 319 of FIG. 3. Next, the modeling application 125 can store the three-dimensional model 136 of the human anatomy 146 in the data store 123, as previously described in the discussion of block 323 of FIG. 3.

Next, the training application 126 can direct the display 103 to render the virtual space, as previously described in the discussion of block 403 of FIG. 4 and further described in the discussion of blocks 503, 506, 509, 513, and 516 of FIG. 5. Next, the training application 126 can receive sensor data from an input device 106, as previously described in the discussion of block 406 of FIG. 4. Next, the training application 126 can cause the surgical instrument 153 to move in the virtual space, as previously described in the discussion of block 409 of FIG. 4. Next, the training application 126 can detect a collision between the surgical instrument 153 and the three-dimensional model 136 of human anatomy 146, as previously described in the discussion of block 413 of FIG. 4. Finally, the training application 126 can provide feedback to the user in response to detecting a collision, as previously described in the discussion of block 416 of FIG. 4. After block 416, the sequence diagram of FIG. 6 ends.

A number of software components previously discussed are stored in the memory of the respective computing devices and are executable by the processor of the respective computing devices. In this respect, the term “executable” means a program file that can be in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) can also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 100.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

In addition to the foregoing, the various embodiments of the present disclosure include, but are not limited to, the embodiments set forth in the following clauses.

Clause 1. A method, comprising: directing a display to render a three-dimensional model of human anatomy in a virtual space; directing the display to render a virtual surgical instrument in the virtual space; receiving movement input from an input device; based on the movement input from the input device, causing the virtual surgical instrument to move on the display; detecting a collision of the virtual surgical instrument and the three-dimensional model of human anatomy in the virtual space; and directing, in response to detecting the collision of the virtual surgical instrument and the three-dimensional model of human anatomy in the virtual space, the input device to provide haptic feedback.

Clause 2. The method of clause 1, wherein the three-dimensional model of human anatomy comprises at least one entry site, one or more bones, one or more organs, or one or more blood vessels.

Clause 3. The method of clause 2, wherein directing the input device to provide haptic feedback further directs the input device to provide stronger haptic feedback when the virtual surgical instrument collides with the one or more bones and weaker haptic feedback when the virtual surgical instrument collides with the one or more organs.

Clause 4. The method of clause 2 or 3, further comprising: directing the display to render at least one name of at least one of a bone, organ, or blood vessel; and directing the display to render at least one safety indicator corresponding to the at least one of a bone, organ, or blood vessel.

Clause 5. The method of clause 4, further comprising, in response to detecting the collision of the virtual surgical instrument and the three-dimensional model of human anatomy in the virtual space, directing the display to update the at least one safety indicator to indicate a collision.

Clause 6. The method of any of clauses 1-5, further comprising directing the display to render a score.

Clause 7. The method of clause 6, further comprising: directing the display to render a score; in response to detecting the collision of the virtual surgical instrument and the three-dimensional model of human anatomy in the virtual space, reducing the score to generate a reduced score; and directing the display to render the reduced score.

Clause 8. The method of any of clauses 1-7, further comprising: receiving a plurality of magnetic resonance imaging (MRI) scans and computerized tomography (CT) scans; identifying a plurality of images in the plurality of MRI scans and CT scans using a three-dimensional slicing software; receiving input that marks the one or more parts of the human anatomy in the plurality of images; identifying the boundaries of the human anatomy in the plurality of images using a grow-from-seeds algorithm; generating a three-dimensional model using the boundaries of the human anatomy in the plurality of images; and applying a gaussian blur to the three-dimensional model.

Clause 9. The method of any of clauses 1-8, wherein the input device comprises: a stylus; a base; and an arm connecting the stylus to the base, wherein the arm detects three-dimensional movement from the stylus as input and wherein the base causes the arm to provide haptic feedback as output.

Clause 10. A method, comprising: directing a display to render a three-dimensional model of human anatomy in a virtual space, the three-dimensional model of human anatomy comprising virtual models of pelvic bones, spinal bones; blood vessels, and a bladder; directing the display to render a virtual retropubic sling trocar in the virtual space; receiving movement input from a stylus; causing the virtual retropubic sling trocar to move on the display corresponding to the movement input; and detecting a collision of the virtual retropubic sling trocar and the three-dimensional model of human anatomy in the virtual space.

Clause 11. The method of clause 10, further comprising: in response to detecting the collision of the virtual retropubic sling trocar and the three-dimensional model of human anatomy in the virtual space, directing a touch feedback device to provide movement resistance to the stylus, wherein the touch feedback device is attached to the stylus.

Clause 12. The method of clause 11, wherein directing the touch feedback device to provide movement resistance to the stylus further causes the touch feedback device to, in response to detecting the collision of the virtual retropubic sling trocar and the pelvic bones, stop the movement of the stylus in one or more directions.

Clause 13. The method of clause 11 or 12, wherein directing the touch feedback device to provide movement resistance to the stylus further comprises: directing the touch feedback device to provide a greater movement resistance when the virtual retropubic sling trocar collides with the pelvic bones; and directing the touch feedback device to provide a lesser movement resistance when the virtual retropubic sling trocar collides with the bladder.

Clause 14. The method of any of clauses 10-13, further comprising directing the display to render a first safety indicator corresponding to the safety of the pelvic bones, a second safety indicator corresponding to the safety of the bladder, and a third safety indicator corresponding to the safety of the blood vessels.

Clause 15. A surgical training system, comprising: a computing device comprising a processor and a memory; and machine readable instructions stored in the memory that, when executed by the processor, cause the computing device to at least: direct a display to render a three-dimensional model of human anatomy in a virtual space; direct the display to render a virtual surgical instrument in the virtual space; receive movement input from an input device; based on the movement input from the input device, cause the virtual surgical instrument to move on the display; detect a collision of the virtual surgical instrument and the three-dimensional model of human anatomy in the virtual space; and in response to detecting the collision of the virtual surgical instrument and the three-dimensional model of human anatomy in the virtual space, direct the input device to provide haptic feedback.

1. A method, comprising:
directing a display to render a three-dimensional model of human anatomy in a virtual space;
directing the display to render a virtual surgical instrument in the virtual space;
receiving movement input from an input device;
based on the movement input from the input device, causing the virtual surgical instrument to move on the display;
detecting a collision of the virtual surgical instrument and the three-dimensional model of human anatomy in the virtual space; and
in response to detecting the collision of the virtual surgical instrument and the three-dimensional model of human anatomy in the virtual space, directing the input device to provide haptic feedback.

2. The method of claim 1, wherein the three-dimensional model of human anatomy comprises at least one entry site, one or more bones, one or more organs, or one or more blood vessels.

3. The method of claim 2, wherein directing the input device to provide haptic feedback further directs the input device to provide stronger haptic feedback when the virtual surgical instrument collides with the one or more bones and weaker haptic feedback when the virtual surgical instrument collides with the one or more organs.

4. The method of claim 2, further comprising:
directing the display to render at least one name of at least one of a bone, organ, or blood vessel; and
directing the display to render at least one safety indicator corresponding to the at least one of a bone, organ, or blood vessel.

5. The method of claim 4, further comprising, in response to detecting the collision of the virtual surgical instrument and the three-dimensional model of human anatomy in the virtual space, directing the display to update the at least one safety indicator to indicate a collision.

6. The method of claim 1, further comprising directing the display to render a score.

7. The method of claim 6, further comprising:
in response to detecting the collision of the virtual surgical instrument and the three-dimensional model of human anatomy in the virtual space, reducing the score to generate a reduced score; and
directing the display to render the reduced score.

8. The method of claim 1, further comprising:
receiving a plurality of magnetic resonance imaging (MRI) scans and computerized tomography (CT) scans;
identifying a plurality of images in the plurality of MRI scans and CT scans using a three-dimensional slicing software;
receiving input that marks the one or more parts of the human anatomy in the plurality of images;
identifying the boundaries of the human anatomy in the plurality of images using a grow-from-seeds algorithm;
generating a three-dimensional model using the boundaries of the human anatomy in the plurality of images; and
applying a gaussian blur to the three-dimensional model.

9. The method of claim 1, wherein the input device comprises:
a stylus;
a base; and
an arm connecting the stylus to the base, wherein the arm detects three-dimensional movement from the stylus as input and wherein the base causes the arm to provide haptic feedback as output.

10. A method, comprising:
directing a display to render a three-dimensional model of human anatomy in a virtual space, the three-dimensional model of human anatomy comprising virtual models of pelvic bones, spinal bones; blood vessels, and a bladder;
directing the display to render a virtual retropubic sling trocar in the virtual space;
receiving movement input from a stylus;
causing the virtual retropubic sling trocar to move on the display corresponding to the movement input; and
detecting a collision of the virtual retropubic sling trocar and the three-dimensional model of human anatomy in the virtual space.

11. The method of claim 10, further comprising:
in response to detecting the collision of the virtual retropubic sling trocar and the three-dimensional model of human anatomy in the virtual space, directing a touch feedback device to provide movement resistance to the stylus, wherein the touch feedback device is attached to the stylus.

12. The method of claim 11, wherein directing the touch feedback device to provide movement resistance to the stylus further causes the touch feedback device to, in response to detecting the collision of the virtual retropubic sling trocar and the pelvic bones, stop the movement of the stylus in one or more directions.

13. The method of claim 11, wherein directing the touch feedback device to provide movement resistance to the stylus further comprises:
directing the touch feedback device to provide a greater movement resistance when the virtual retropubic sling trocar collides with the pelvic bones; and
directing the touch feedback device to provide a lesser movement resistance when the virtual retropubic sling trocar collides with the bladder.

14. The method of claim 10, further comprising directing the display to render a first safety indicator corresponding to the safety of the pelvic bones, a second safety indicator corresponding to the safety of the bladder, and a third safety indicator corresponding to the safety of the blood vessels.

15. A surgical training system, comprising:
a computing device comprising a processor and a memory; and
machine readable instructions stored in the memory that, when executed by the processor, cause the computing device to at least:
direct a display to render a three-dimensional model of human anatomy in a virtual space;
direct the display to render a virtual surgical instrument in the virtual space;
receive movement input from an input device;
based on the movement input from the input device, cause the virtual surgical instrument to move on the display;
detect a collision of the virtual surgical instrument and the three-dimensional model of human anatomy in the virtual space; and
in response to detecting the collision of the virtual surgical instrument and the three-dimensional model of human anatomy in the virtual space, direct the input device to provide haptic feedback.
